(19) United States
(12) Patent Application Publication
(10) Pub. No.: US 2025/0208036 A1
(43) Pub. Date: Jun. 26, 2025

(54) COMPACT TOC ANALYZER WITH INTEGRATED CARRIER GAS PREPARATION

(71) Applicant: Endress+Hauser Conducta GmbH+Co. KG, Gerlingen (DE)

(72) Inventors: Christian Cramer, Stuttgart (DE); Eva-Maria Petat, Stuttgart (DE); Maik Röder, Benningen (DE); Daniel Schweitzer, Remshalden (DE); Kay Steen, Leinfelden-Echterdingen (DE); Ulrich Kathe, Ludwigsburg (DE)

(21) Appl. No.: 18/980,495

(22) Filed: Dec. 13, 2024

(30) Foreign Application Priority Data
Dec. 22, 2023 (DE) 10 2023 136 472.3

(51) Int. Cl. G01N 21/3577; G01N 31/12

(52) U.S. Cl. CPC G01N 21/3577; G01N 31/12

(57) ABSTRACT

A method for producing a purified carrier gas for a TOC analyzer from ambient air includes: guiding a carrier gas consisting of ambient air from an inlet of the TOC analyzer through at least one filter, at least one flow sensor, a humidifier to a pre-combustor in which organic impurities in the air are oxidized to CO2 at 680° C. or more, and a CO2 absorber, for example, comprising soda lime, which adsorbs CO2 arising in the pre-combustor.

### CROSS-REFERENCE TO RELATED APPLICATION

The present application is related to and claims the priority benefit of German Patent Application No. 10 2023 136 472.3, filed Dec. 22, 2023, the entire contents of which are incorporated herein by reference.

### TECHNICAL FIELD

The following invention relates to a TOC analyzer with integrated carrier gas preparation, a method for preparing a carrier gas from ambient air, as well as a method for measuring the TOC content with the TOC analyzer according to the present disclosure.

### BACKGROUND

When determining the total organic carbon (TOC) of a liquid sample, the organic components are oxidized to form carbon dioxide (CO₂). In liquid samples, the carbon contained therein is typically converted to carbon dioxide either in a wet-chemical manner or using UV or combustion methods. The sample is combusted in a high-temperature furnace at 680-1200° C. In combustion methods (in particular at temperatures of <1000° C.), a catalyst is often used to ensure complete oxidation. In aqueous samples, therefore, in addition to carbon dioxide and other combustion gases, water vapor also arises and is generally condensed after the combustion and separated from the carbon dioxide gas. Before the carbon dioxide gas is passed into the analysis unit, dusts, aerosols, and other gas constituents are sometimes removed from the carbon dioxide gas using filters and absorbers or adsorbers. The resulting CO₂ is guided with the help of a carrier gas to a detector, where the CO₂ is measured.

From the measured amount of CO₂, the organic carbon originally present in the sample can then be directly deduced. When analyzing the TOC, it is essential for the carrier gas used in the analyzer to be free of CO₂ since this would otherwise distort the measurement results.

Oxygen or mixtures of oxygen with nitrogen, (treated) compressed air and ambient air are used carrier gases, wherein this air must be purified of organic compounds in order to be CO₂-free. When using ambient air, it is necessary for it to be free of CO₂ or other carbon-containing compounds, preferably organic chemical compounds. The carbon content is determined by means of a non-dispersive infrared (NDIR) sensor.

Supplying via external gas sources depends on the one hand on the central gas supply, which is not available everywhere where analyzers are used. The alternative option of an external gas supply using portable canisters is expensive.

When using ambient air, the air is treated outside the analysis device. External air treatment requires a compressor which takes up a lot of space and is expensive.

### SUMMARY

Based on the prior art, the object of the present disclosure is to therefore provide a compact TOC analysis device which does not require the use of external carrier gas sources.

This object is achieved by the TOC analyzer according to the present disclosure for determining a carbon content of a sample, comprising:
an inlet for a carrier gas into the TOC analyzer, wherein the carrier gas is designed to be guided to a high-temperature furnace via:
   at least one filter,
   at least one flow sensor,
   a humidifier,
   a pre-combustor which is designed as a high-temperature combustor to oxidize organic impurities in the air into CO₂,
   a CO₂ absorber, for example, comprising soda lime, and
   at least one pump,
wherein the high-temperature furnace is designed to evaporate or oxidize the sample at a high temperature to form water vapor and carbon dioxide gas,
the carrier gas is formed to transport to an analysis unit the carbon dioxide gas produced during oxidation of the sample in the high-temperature furnace, and
the at least one flow sensor and the at least one pump are designed to regulate the flow of the carrier gas through the high-temperature furnace;
an injection unit that is configured to inject a liquid sample into the high-temperature furnace;
the analysis unit is designed to measure the carbon content of the sample on the basis of the carbon dioxide gas resulting from the oxidation of the sample; and
a data processing unit that is designed to perform the following steps:
   control the carrier gas flow through the at least one pump and the at least one flow sensor;
   control and/or regulate the injection unit and
   determine the carbon content of the sample.

In one embodiment, the introduced carrier gas consists of ambient air.

In one embodiment, a condensation unit and an acid filter are arranged between the high-temperature furnace and the analysis unit.

A high-temperature furnace is usually operated at 680-1,200° C. In the methods according to the present disclosure, a temperature of 680° C. is preferred.

The condensation unit is designed to condense the resulting water vapor in the high-temperature furnace. The acid filter is designed to remove aerosols from the gas stream.

In one embodiment, the at least one pump is at least a diaphragm pump. In one embodiment, the at least one diaphragm pump is designed to achieve a pressure of 400 mbar.

In one embodiment, the analysis unit comprises a non-dispersive infrared (NDIR) sensor.

In one embodiment, a flow sensor is connected downstream from the filter and the analysis unit.

The present disclosure also relates to a method for producing a purified carrier gas for a TOC analyzer from ambient air, wherein the method comprises:
guiding a carrier gas consisting of ambient air from an inlet of the TOC analyzer through
at least one filter,
at least one flow sensor,
a humidifier
a pre-combustor in which organic impurities in the air are oxidized to CO₂ at 680° C. or more, and
a CO₂ absorber, for example, comprising soda lime which adsorbs CO₂ produced in the pre-combustor, to a storage vessel or to a high-temperature furnace, wherein the treatment takes place inside a TOC analyzer.

In one embodiment of the TOC analyzer according to the present disclosure or the method for producing a purified carrier gas, the filter has a pore size of 5 μm or less than 5 μm.

The present disclosure also relates to a method for determining a carbon content of a sample in a TOC analyzer according to the present disclosure or an embodiment thereof, comprising the steps of:
(i) guiding a carrier gas from an inlet of the TOC analyzer through:
   at least one filter,
   at least one flow sensor,
   a humidifier,
   a pre-combustor that oxidizes organic air impurities at 680° C. or more into CO₂,
   a CO₂ absorber, for example, comprising soda lime,
   at least one pump, and
   a high-temperature furnace, to an analysis unit;
(ii) optionally stopping the flow of the carrier gas through the high temperature furnace;
(iii) injecting the sample into the high temperature furnace using the injection unit;
(iv) evaporating and/or oxidizing the sample at 680° C. or more to form water vapor and carbon dioxide gas until the sample injected into the high temperature furnace is evaporated;
(v) starting the flow of the carrier gas through the high-temperature furnace and thereby transporting to an analysis unit the carbon dioxide gas produced during the vaporization and/or oxidation of the sample; and
(vi) determining the carbon content of the sample by means of the analysis unit on the basis of the carbon dioxide gas produced during the oxidation of the sample, wherein the introduced carrier gas consists of ambient air.

In one embodiment of the method for producing a purified carrier gas or the method for determining a carbon content, oxidation catalysts-selected from platinum (Pt) and palladium (Pd), which were applied as active components to a heat-resistant carrier material selected from Al₂O₃ or SiO₂—are added during evaporation of the water and/or oxidation of the sample at 680° C. or more to form water vapor and carbon dioxide gas.

In embodiments where volumes of 1,000 μL or more of sample are injected, the flow of carrier gas is stopped during injection. In embodiments where volumes of 100-200 μL, for example, 100 μL, are injected, the flow of the purified carrier gas is not stopped.

All the embodiments of the TOC analyzer and the method described above can be combined with each other in each case, provided that this is technically possible.

### BRIEF DESCRIPTION OF THE DRAWINGS

The present disclosure is explained in more detail in the following description with reference to the embodiments shown in the drawing.

FIG. 1 shows the layout of a TOC analyzer according to the present disclosure.

### DETAILED DESCRIPTION

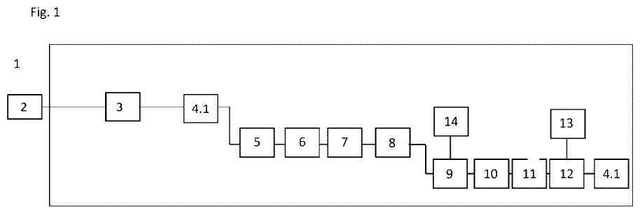

FIG. 1 shows a layout of an embodiment of a TOC analyzer (1) according to the present disclosure. Ambient air is guided through an inlet (2) of the TOC analyzer (1), through at least one filter (3), two flow sensors (4.1, 4.2), and a humidifier (5), to a pre-combustor (6) in which organic impurities in the air are oxidized into CO₂ at 680° C. or more, and a CO₂ absorber (7), for example, comprising soda lime, which absorbs CO₂, thereby obtaining purified carrier gas. This purified carrier gas is then fed to a high-temperature furnace (9) via a pump (8), for example, a diaphragm pump.

The flow of the purified carrier gas is stopped at injection volumes of 1,000 μL or more, and the liquid sample to be analyzed is injected into the high-temperature furnace (9) via an injection unit (14). In a preceding step, inorganic carbon compounds are removed from the liquid sample; in this step, purified carrier gas can also be used as a carrier gas. A condensation unit (10) and an acid filter (11) may be arranged downstream of the high-temperature furnace (9).

The sample to be analyzed is evaporated under high temperature conditions, for example, at 680° C. or more, for example, at 680-1200° C., and converted to CO₂. The carrier gas transports to an analysis unit (12) the carbon dioxide gas produced during the evaporation and/or oxidation of the sample. The analysis unit (12), comprising an NDIR sensor, determines the carbon content of the sample based on the carbon dioxide gas produced during the oxidation of the sample in the carrier gas stream with purified carrier gas. The TOC analyzer (1) also comprises a data processing unit (13) which is designed to control the carrier gas flow through the at least one pump (8) or the at least one flow sensor, to control and/or regulate the injection unit (14), and to determine the carbon content of the sample.

The carrier gas introduced into the TOC analyzer consists of ambient air. Flow sensors (4.1-4.2) control the flow rate of the carrier gas.

We claim:

1. A total organic carbon (TOC) analyzer for determining a carbon content of a sample, the TOC analyzer comprising:
an inlet adapted to enable introducing a carrier gas into the TOC analyzer;
at least one filter arranged downstream of the inlet;
at least one flow sensor arranged downstream of the inlet;
a humidifier arranged downstream of the inlet;
a pre-combustor arranged downstream of the inlet and configured to oxidize organic impurities in the carrier gas into carbon dioxide gas (CO₂);
a carbon dioxide absorber arranged downstream of the pre-combustor;
at least one pump arranged downstream of the inlet;
a high-temperature furnace configured to evaporate and/or oxidize the sample at a high temperature to form water vapor and carbon dioxide gas, wherein the at least one flow sensor and the at least one pump are adapted to regulate a flow of the carrier gas through the high-temperature furnace;
an injection unit configured to inject the sample into the high-temperature furnace;
an analysis unit configured to measure the carbon content of the sample based on the carbon dioxide gas from the evaporation and/or oxidation of the sample in the high-temperature furnace,
wherein the analyzer is configured to convey the carrier gas to the high-temperature furnace, which further transports the carbon dioxide gas produced during oxidation of the sample in the high-temperature furnace to the analysis unit; and
a data processing unit configured to:
control the flow of the carrier gas via the at least one pump and/or the at least one flow sensor;
control and/or regulate the injection unit; and
determine the carbon content of the sample.

2. The TOC analyzer according to claim 1, wherein the carbon dioxide absorber includes soda lime.

3. The TOC analyzer according to claim 1, wherein the introduced carrier gas consists of ambient air.

4. The TOC analyzer according to claim 1, further comprising a condensation unit and an acid filter, each arranged between the high-temperature furnace and the analysis unit.

5. The TOC analyzer according to claim 1, wherein the at least one pump includes at least one diaphragm pump.

6. The TOC analyzer according to claim 5, wherein the at least one diaphragm pump is operable to generate a pressure of 400 mbar.

7. The TOC analyzer according to claim 1, wherein the analysis unit comprises a non-dispersive infrared sensor.

8. The TOC analyzer according to claim 1, wherein a first flow sensor of the at least one flow sensor is connected downstream of the at least one filter, and a second flow sensor of the at least one flow sensor is connected downstream of the analysis unit.

9. The TOC analyzer according to claim 1, wherein the at least one filter has a pore size of 5 μm or less than 5 μm.

10. A method for producing a purified carrier gas for a total organic carbon (TOC) analyzer from ambient air, the method comprising:
passing an unconditioned carrier gas consisting of ambient air from an inlet of the TOC analyzer through:
at least one filter;
at least one flow sensor;
a humidifier;
a pre-combustor adapted to oxidize organic impurities in the air to carbon dioxide (CO₂) at 680° C. or more; and
a CO₂ absorber configured to adsorb CO₂ generated in the pre-combustor,
to a storage vessel or a high-temperature furnace, wherein the producing of the purified carrier gas is effected within the TOC analyzer.

11. The method according to claim 10, wherein the at least one filter has a pore size of 5 μm or less than 5 μm.

12. The method according to claim 10, further comprising evaporating and oxidizing the sample at 680° C. or more in a high-temperature furnace to form water vapor and carbon dioxide gas until the sample injected into the high temperature furnace is evaporated, wherein an oxidation catalyst is added during the evaporating and/or oxidating of the sample, wherein the oxidation catalyst is at least one of platinum and palladium applied as an active component to a heat-resistant carrier material selected from Al₂O₃ or SiO₂.

13. A purified compressed air for a total organic carbon (TOC) analyzer, wherein the purified air is produced according to the method of claim 10, and wherein the purified air is subsequently compressed.

14. A method for determining a carbon content of a sample in a TOC analyzer according to claim 1, the method comprising:
passing the carrier gas from the inlet of the TOC analyzer through:
the at least one filter;
the at least one flow sensor;
the humidifier;
the pre-combustor configured to oxidize the organic impurities at 680° C. or more into CO₂,
the CO₂ absorber;
the at least one pump; and
the high-temperature furnace,
to an analysis unit;
injecting the sample into the high-temperature furnace using the injection unit;
evaporating and oxidizing the sample at 680° C. or more in the high-temperature furnace to form water vapor and carbon dioxide gas until the sample injected into the high temperature furnace is evaporated;
continuing the flow of the carrier gas through the high-temperature furnace and thereby transporting the carbon dioxide gas produced during the evaporation and/or oxidation of the sample to the analysis unit; and
determining the carbon content of the sample with the analysis unit based on the carbon dioxide gas produced during the oxidation of the sample, wherein the introduced carrier gas consists of ambient air.

15. The method according to claim 14, further comprising stopping the flow of the carrier gas through the high temperature furnace prior to injecting the sample into the high-temperature furnace.

16. The method according to claim 14, wherein an oxidation catalyst is added during the evaporating and oxidating of the sample, wherein the oxidation catalyst is at least one of platinum and palladium applied as an active component to a heat-resistant carrier material selected from Al₂O₃ or SiO₂.
